(19) United States
(12) Patent Application Publication
(10) Pub. No.: US 2010/0321319 A1
(43) Pub. Date: Dec. 23, 2010

(54) METHOD FOR DISPLAYING AND UPDATING A VIEW OF A GRAPHICAL SCENE IN RESPONSE TO COMMANDS VIA A TOUCH-SENSITIVE DEVICE

(76) Inventor: Thierry HEFTI, Gland (CH)

Correspondence Address: DLA PIPER LLP (US);ATTN: PATENT GROUP, P.O. Box 2758, Reston, VA, 20195, US

(21) Appl. No.: 12/817,117

(22) Filed: Jun. 16, 2010

Related U.S. Application Data
(60) Provisional application No. 61/187,705, filed on Jun. 17, 2009.

(51) Int. Cl. G06F 3/041

(52) U.S. Cl. 345/173

(57) ABSTRACT

A man-machine interface using a touch-sensitive device as an interface to a computer device is presented, wherein simple gestures made by a user are interpreted by the computer device as commands to be performed in respect to at least a part of a virtual environment shown on the display. Each sequence of gestures begins with an initial touch on the touch-sensitive device and may involve a number of subsequent gestures. A command thus given is applied to the part of the virtual environment on the display. The action of the command continues until the gesture is ended by the user removing contact from the touch-sensitive device, thus ending the command.

### INTRODUCTION

The present invention relates to the domain of man-machine interface techniques and more precisely to the processing of commands given to a computer device via a touch-sensitive interface in applications such as computer games.

### STATE OF THE ART

Touch-sensitive devices have proved a useful means for communicating with a computer device, especially in applications which are graphics-oriented, such as manipulating a view of a graphical representation of a particular space or manipulating a virtual object within a virtual space. Such capabilities are useful in gaming applications or in control applications where a graphical representation of a virtual piece of apparatus may be manipulated in order to control the apparatus in the real world, for example.

U.S. Pat. No. 7,477,243 B2 provides a useful background to the subject matter described in the present invention, wherein a virtual space shift control apparatus is provided. The apparatus has a touch-sensitive display on which a virtual space image is displayed. Based upon a touch input comprising at least two simultaneous touch positions or a touch-and-drag manipulation, a new display is generated showing the virtual space image as viewed from a different viewpoint. This document does not teach how to move virtual objects relative to the virtual space.

In gaming applications it is desirable to be able to move a graphical object within a virtual space. Such an application is described in United States Patent Application Publication Number 2006/0025218 A1, wherein two pointing positions on a touch-sensitive display are detected simultaneously. Using the distance between the two pointing positions and the angle between the two pointing positions, a movement parameter comprising a virtual distance and angle can be calculated and applied to the graphical object in order to move it that, virtual distance and angle relative to a starting point within the virtual space. Change amounts in distance and angle can also be used to calculate speed and turning angle to be further applied to the graphical object. This description teaches that such calculations are done on the basis of at least two simultaneous pointing positions and as such each movement will be defined in a closed-ended manner once the two positions have been registered. The range of application of each movement is therefore defined and bound by the two pointing positions, with no means for continuing a movement outwith the range of a displayed part of a virtual space.

Computer-aided control of remote external devices is described in U.S. Pat. No. 6,160,551, wherein a graphical user interface to the computer device, based on a geographic map structure is provided. A plurality of spaces within the geographic map structure is represented on a touch-sensitive display as graphic images of geographic spaces. Within each space, a plurality of objects is shown. The objects may be selected and manipulated by a user. An object can be a portal, which allows for the user to access a new geographic space, or it can be a button, which allows for an action or function to be performed. In this description, there is a direct correlation between a touch gesture and an effect on an object in that whenever a gesture is terminated or paused, the effect on the object will also terminate or pause.

### SUMMARY OF THE INVENTION

The present invention provides for a method for displaying a current view of a graphical scene on a display by a computer device comprising a touch-sensitive device, said method comprising the following steps:
detecting at least one pressure point on the touch-sensitive device and determining a set of coordinates for said pressure point,
detecting at least one displacement of the pressure point while pressure is maintained on the touch-sensitive device and determining at least one further set of coordinates along a locus described by said displacement,
calculating at least a direction attribute based on the plurality of sets of coordinates,
updating the current view by moving at least part of the current view according to at least the direction attribute,
continuing to update the current view by moving at least part of the current view according to the direction attribute until the pressure is released from the touch-sensitive device.

By continuing to apply a command described by such a drag gesture even after the gesture has come to a stop, the limitations to the range to which such commands can apply, due to the small size of the displays on most portable devices, are overcome using the method taught by the present invention.

### BRIEF DESCRIPTION OF THE DRAWINGS

The present invention will best be understood by referring to the following detailed description of preferred embodiments when read in conjunction with the accompanying drawings, wherein:

FIG. 1 shows a schematic representation of an input being made to a computer device via a touch-sensitive display according to an embodiment of the present invention.

FIG. 2 shows a schematic representation of an input being made in multiple successive gestures to a computer device via a touch-sensitive device according to another embodiment of the present invention.

FIG. 3 shows an example of how an attribute associated with a touch input may be communicated via the touch-sensitive display according to an embodiment of the present invention.

FIG. 4 shows an example of how a plurality of gestures via a touch-sensitive display can be combined for processing according to an embodiment of the present invention.

FIG. 5 shows how a rotate command can be communicated via the touch-sensitive device.

FIG. 6 shows how different zoom commands can be communicated via the touch-sensitive device.

### DETAILED DESCRIPTION OF A PREFERRED EMBODIMENT

The use of a touch-sensitive device to input commands to a computer device has been described in prior art. Similarly, techniques for manipulating graphical objects in a virtual space have been demonstrated, however these suffer from a problem posed in a particular situation where navigation within a virtual space, or graphical scene, is to be represented on a display, wherein the virtual space in its entirety is too large to fit on the display and only part of the virtual space is displayed at one time. This could especially be the case if the display were of the type commonly used on popular hand-held devices.

Consider a gaming application run on a computer device for example, in which a graphical scene, comprising a graphical background and at least one graphical object or “character”, is displayed on a touch-sensitive display. In this case then, the touch-sensitive device referred to in the present invention is the touch-sensitive display. The touch-sensitive display is connected to the computer device and, as well as displaying the aforementioned graphics, it is used as a command interface to the computer device. Through the course of the game it may be required to portray the movement of the character within the graphical scene. This can be done by the computer device periodically updating the display to show the character in a new position relative to the graphical background—either by portraying the character at a new position on the screen while the background remains stationary or by keeping the character more or less stationary and portraying an updated version of the background. If the touch-sensitive display is small, it may only be possible to display a portion of the graphical scene. We refer to such a portion as a current view of the graphical scene. Given the small size of the display, it is likely that the movement imposed on the character would quickly require the character to be pushed outside of the current view. For this reason it is not possible to immediately indicate the destination of the character on the touch-sensitive display since it is out of range.

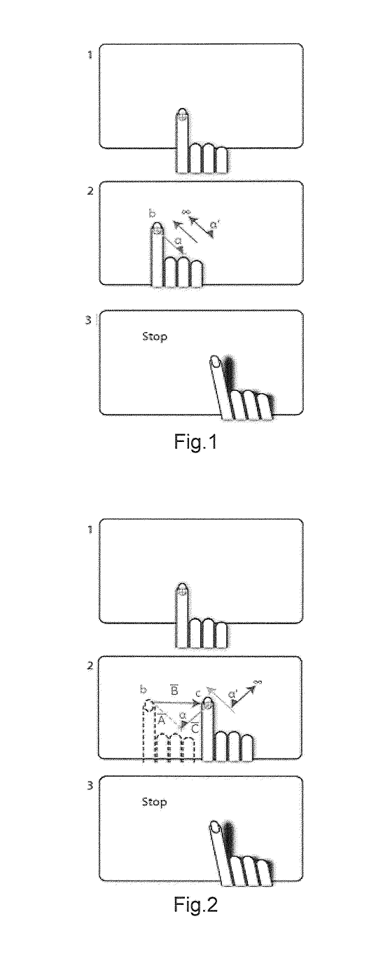

Continuing with the gaming application example, which involves maneuvering a graphical object or character within a graphical scene, which could be 3-dimensional or a 2-dimensional representation of a virtual environment, reference is made to FIG. 1. In the type of game referred to in this example, a player has to navigate around the virtual environment. The player is generally represented by the graphical object or character referred to earlier. According to a preferred embodiment of the present invention, certain sequences of gestures performed on the touch-sensitive display are interpreted by the computer device as commands affecting the movement of the character. One such sequences of gestures is a touch and a drag as illustrated in FIG. 1. The touch gesture indicates a first point of contact. A drag gesture means maintaining pressure on the display while displacing the point of contact and is interpreted as a move command. The move command requires a direction attribute. The direction attribute is calculated from the direction of the drag gesture. The object is therefore moved in a direction calculated using the direction of the drag gesture. The movement of the object continues, even if the drag gesture comes to a stop. The movement of the object stops when contact with the touch-sensitive display is ceased. The sequence of gestures, including the touch and the drag, is therefore terminated by removing contact from the display and not merely by bringing the drag gesture to a stop. Terminating the sequence of gestures terminates the action of the command. This is illustrated in FIG. 1, wherein a graphical view is shown with a character at point a′. A player makes a first point of contact with the touch-sensitive display, using his finger, at point a then slides his finger from point a to point b, wherein point b is at an angle ø from point a. The command therefore interpreted by the computer device is to move the character at point a′ in a direction indicated by the angle ø. The character keeps moving in the same direction until the user lifts his finger, causing the character stop moving.

According to one embodiment of the present invention, when we say that the character is moved, what is actually occurring is that the current view of the graphical scene is updated by drawing the character in a new position, dictated by the move command and the direction attribute, with respect to the graphical background.

In the case where the current view represents only a part of the graphical scene, the consequence of the move operation carried out on the character may be that the character reaches a boundary of the current view before the contact with the display is removed. Since the move operation continues until contact with the touch-sensitive display is removed, the character should keep moving relative to the graphical background even though it has reached or is approaching a boundary of the display. One way to deal with this situation is to keep the object around the same position at or near the boundary and to move the background to reproduce the same effect as if the object were moving. In this case the background is redrawn, adding new information, as required, from the graphical scene to the current view. Other variations of this are possible, for example a new graphical view or a frame could be drawn once the character gets close to a boundary. The new frame would place the character somewhere near the middle of the display again and the background would be redrawn, with new information being added as required to fill in parts of the graphical scene which were not included in the previous graphical view or frame. In this case it may be desirable to try to retain a certain amount of continuity between frames by making sure that there is some amount of overlap in the current frame compared to a previous frame when the graphical object is brought back near the centre of the display and the background redrawn as a consequence. In a preferred embodiment of the present invention however, the character remains substantially stationary at a point near the middle or towards the bottom of the display and the view is periodically updated using new information from the graphical scene depending on the direction given by the move command in order to show the graphical object in the same position relative to the touch-sensitive display but in a new position relative to the graphical background to reflect the effect of the move on the character.

The above example relates to a game played on a computer device within a hand-held device where commands are input to the computer device via a touch-sensitive display on the hand-held device and the game is displayed on the same touch-sensitive display, however in another embodiment of the present invention, the game could be played on a remote computer device with the touch-sensitive device acting merely as a command interface to the computer device. The display of the game could either be made on the touch-sensitive device itself or on a display which is remote from the touch-sensitive device.

FIG. 2 shows an example of how the sequence of gestures may be continued before removing contact from the touch-sensitive device and how such gestures are interpreted according to an embodiment of the present invention. For example, referring to FIG. 2, following an initial touch (a) on the touch-sensitive device, the finger is dragged to point b, brought to a stop and subsequently dragged in a new direction towards a point c. As a result, according to an embodiment of the present invention, the character is moved in a direction corresponding to a combination of the two moves. For example, the first drag could be described by a vector (Ā) and the second drag by a vector ( B̅), then the resulting direction of a move made on the character is based on the sum of the two vectors ( C̅=Ā+ B̅). The move is continued in the calculated direction until such time as the sequence of gestures is terminated by removing the touch from the touch-sensitive device.

In a preferred embodiment of the present invention, such sequences of continued gestures without removing contact from the touch-sensitive device are interpreted as providing new information in order to update a direction attribute initially calculated for a command. In this case the initial point of contact is retained as an origin for the calculation of subsequent direction attributes. For example, in FIG. 2, during the time that the first drag is being performed, the view may already begin to be updated to portray a move of the character in the direction of vector Ā. That is to say that the direction attribute will be periodically calculated during the drag using points along the locus of the drag. If vector Ā is made up of Ā1 and Ā2, then direction attributes could be calculated at the end of Ā1 and at the end of Ā2. When the second drag is initiated in the direction of vector B̅, where B̅ is made up of B̅1 and B̅2, then a new point may be taken at the end of B̅1 and the direction attribute modified according to the sum Ā+ B̅1. Similarly, the direction attribute would be subsequently modified according to the sum of Ā+ B̅.

In another embodiment of the present invention, rather than taking the first point of contact as an origin for calculating all subsequent modifications to the direction attribute, combinations of most recent segments of drag gestures could be used to update the direction attribute. For example Ā2 is used to calculate a first direction, then Ā1+Ā2 is used to confirm the same direction, then Ā2+ B̅1 is used to change the direction and finally to continue in the changed direction using B̅1+ B̅2. In other words, various memory depths of previous drag segments could be involved in the calculation of the direction. At one extreme of this process, rather than combining segments of drag gestures, we arrive at simply the last detected segment of a drag gesture being used to determine the direction attribute. Again, using FIG. 2 as an example, the first direction is given by Ā1, the second direction by Ā2, the third direction by B̅1 and the fourth direction by B̅2.

Rather than describing a straight line, a drag gesture may describe a more complex locus, such as a curve or a series of curves in various directions. For example, if the drag gesture involves a slow-moving curve, then the direction attribute may be updated at various points along the curve by using a number of points along the curve. For a fast-moving gesture which comes to a stop, it may suffice to use the initial point of contact and the point where the drag stops to calculate the direction attribute.

So far the move command thus described is associated with a direction attribute. According to an embodiment of the present invention a speed attribute is also required to properly qualify a move command. Thus, in a similar way that vector quantities are defined by a magnitude and a direction, a move command is defined by the speed (c.f. magnitude) and direction attributes. Indeed, a drag gesture up until a stop, or even part of a drag gesture, may be regarded as a vector. Such vectors, describing subsequent drags or parts of drags may be combined according to the normal treatment of vector quantities in order to form new move commands with new speed and direction attributes.

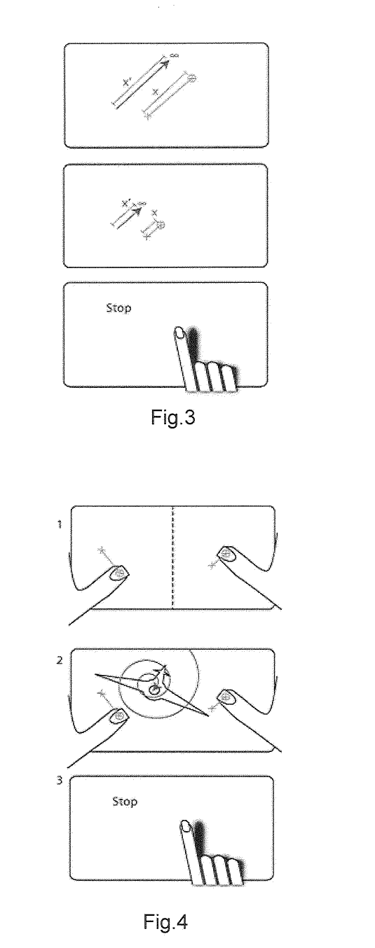

FIG. 3 shows an example of how the length of a displacement made by a drag up to a stop point may be interpreted as the speed attribute according to a preferred embodiment of the present invention. In this example, the longer the displacement described by the drag, the larger the speed attribute and so the faster the character is moved. According to another embodiment of the present invention the speed attribute may be calculated using the speed of a drag gesture rather than the distance of the drag. In this case, two sets of coordinates are taken along the locus of the drag gesture and the time interval between the two points is used to calculate a speed attribute.

The character in a game may be of a more complex type allowing for more complex movements than just the displacements which have been described until now. For example, the character could be a vehicle such as a tank. In this case a drag gesture could be interpreted as a simple displacement applied to the entire tank, as before, however other possibilities exist, such as assigning one gesture to one side of the tank and assigning a subsequent, possibly simultaneous, gesture to the other side of the tank. The assignment of each gesture to one side of the tank could simply be made according to the position of each gesture relative to the tank or relative to the screen, with left side gestures being applicable to the left drive sprockets for the left tracks and right side gestures for right side drive sprockets and tracks. It is easy therefore to see how multiple simultaneous gestures can be used to manipulate a tank in this way, including simple displacements, changes of speed and turning.

FIG. 4 shows another example of multiple simultaneous gestures as applied to an airplane. In this case, the airplane is of a type capable of achieving vertical take-off and landing. With the airplane's engines configured to achieve vertical boost, left and right simultaneous drag gestures are used control the amount of lift generated on each side of the aircraft, causing the aircraft to spin. Since, according to an embodiment of the present invention, the effect of a command persists until pressure is removed from the touch-sensitive device, the airplane continues to spin as long as pressure is maintained on the touch-sensitive device.

Instead of multiple simultaneous gestures each having effect on separate parts of a single character, each of these gestures could instead have effect on multiple characters in another embodiment of the present invention. The choice of which character to be affected by a particular gesture could be based either on the proximity of a gesture to a character or by having predefined zones on the touch-sensitive device being applicable to certain characters. Since it is possible under this scheme to move, say two different characters in very different directions, the updating of the display once one of the characters reaches a boundary has to be based on only one of the two characters. A priority protocol is therefore established whereby one of the characters is attributed a higher priority and the updating is done relative to that character. For example, the priority could be based on which character moves first, or which character reaches a boundary first, or by defining zones wherein a character finding itself in such a zone has priority or by predefining priorities for each character.

In a preferred embodiment of the present invention the touch-sensitive interface is divided into a plurality of zones, these zones being either hardwired or attributed dynamically depending on the context of the application being run. In this way, gestures made on different parts of the touch-sensitive device can have different meanings. For example, if the character is a tank, then gestures made on the right side of the touch-sensitive device could affect movement of the character within the virtual environment whereas gestures made to the left side of the touch-sensitive device could affect the gun position. Similarly, if the character were a soldier, then gestures made on the right side could affect the soldier's movement while gestures on the right side could affect the viewing angle of a virtual camera behind the soldier or on his helmet or simply the direction that the soldier is looking or pointing his gun. In general terms then, the current view is updated according to a combination of the gestures made on both sides of the touch-sensitive device. The designation of zones could of course be extrapolated to being more than just left and right.

Throughout the game the designation of zones on the touch-sensitive device, and therefore the effects of gestures made within such zones, may vary depending on the context. The context may change depending on a situation punctually presented to the player during the running of the game or changes in context may be forced by the player entering a command. Such commands may be entered by touching special zones of the touch-sensitive device which could either be predefined or could be indicated by a special icon or button. Otherwise a command could be entered using an entirely different gesture than the touch and drag gesture described thus far (see below). With this possibility of special zones or the presence of buttons it becomes necessary to further define priorities of gestures. For example, if a touch and drag gesture were to end up on a button, the move function would take priority over any effect that touching the button might normally have had. Buttons serve not only to change context, but can have various different dedicated functions. For example, touching a button could allow for the selection of a different weapon.

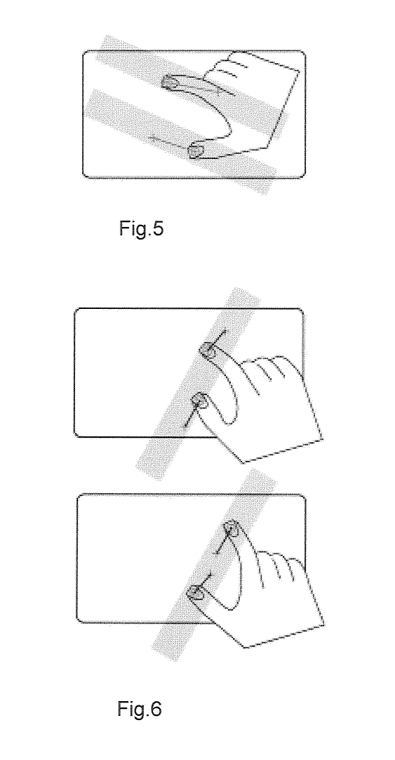

FIG. 5 shows how a rotate command can be given to the computer device via the touch-sensitive device using two points of contact, according to an embodiment of the present invention, while FIG. 6 illustrates the use of two points of contact to give zoom commands. In FIG. 5, two separate points of contact are made on the touch-sensitive device. Each of the contact points is then moved or dragged in substantially opposing directions, thus describing opposing vectors. Similarly, in both of the images shown in FIG. 6, two contact points are moved in substantially opposing directions—in one image the contact points are brought together and in the other they are moved apart. In FIG. 5 however, the vectors described by the two drags lie on separate axes, while the vectors described by both drags in each of the two images of FIG. 6 lie on a single axis in both cases. In this way, three different commands can be described using these gestures: simultaneous drags in substantially opposing directions lying on separate axes lead to rotate commands, while simultaneous drags in substantially opposing directions lying on the same axis lead to zoom in commands when the two points of contact approach each other or to zoom out commands when the two points of contact move away from each other.

According to an embodiment of the present invention, the touch-sensitive device could be used to input commands to the computer device other than simply displacement, rotation, zooming and change of viewing angle as described above. Indeed, other gestures and sequences of gestures can be used to define a range of different commands, some examples of which are given below:
tap (rapid touch and release on touch-sensitive device);
double-tap (two taps in quick succession);
touch-drag (the move command as described above);
touch-drag-hold (the continuous move command described above);
double-touch-drag (two touch-drags in quick succession);
double-touch-drag-hold (two touch-drags in quick succession while maintaining pressure on touch-sensitive device following second touch-drag).

The number of possible commands available using the above gestures can of course be augmented by adding the direction of a drag as a variable. For example, one command could be invoked by a double-touch-drag towards the top-right of the touch-sensitive device while a double-touch-drag towards the bottom left could invoke a different command.

A description is thus given of a method and a system for inputting commands to a computer device using a touch-sensitive device, and more particularly to allow for the possibility of some commands, such as “move” type commands, to be applicable as long as contact is maintained with the touch-sensitive device, thus requiring a current view of the graphical scene to be periodically updated.

1. A method for displaying a current view of a graphical scene on a display by a computer device comprising a touch-sensitive device, said method comprising the following steps:
detecting at least one pressure point on the touch-sensitive device and determining a set of coordinates for said pressure point,
detecting at least one displacement of the pressure point while pressure is maintained on the touch-sensitive device and determining at least one further set of coordinates along a locus described by said displacement,
calculating at least a direction attribute based on the plurality of sets of coordinates,
updating the current view by moving at least part of the current view according to at least the direction attribute,
continuing to update the current view by moving at least part of the current view according to at least the direction attribute until the pressure is released from the touch-sensitive device.

2. The method according to claim 1, wherein said graphical scene comprises at least one graphical object on a graphical background, said graphical object being detached from said graphical background, wherein said update of the current view comprises the following step:
re-drawing the graphical background to reflect a move of the graphical object relative to the graphical background while keeping the graphical object substantially static with respect to the display.

3. The method according to claim 1, wherein said graphical scene comprises at least one graphical object on a graphical background, said graphical object being detached from said graphical background, wherein said update of the current view comprises the following steps:
drawing said graphical object in a new position with respect to the graphical background, said graphical background remaining substantially static,
if the new position of the thus drawn graphical object is within a predetermined distance from an edge of the display, then re-drawing the graphical background.

4. The method according to claim 3, wherein a plurality of pressure points are detected, each of said plurality of pressure points being mapped to a plurality of graphical objects, said plurality of displacements giving a plurality of direction attributes, each of said direction attributes being applied to its corresponding graphical object.

5. The method according to claim 1, wherein it comprises the step of calculating at least a speed attribute based on the plurality of sets of coordinates.

6. The method according to claim 5, wherein the method comprises the step of determining at least one stop of the displacement when the pressure remains substantially at the same position, the calculation of the speed attribute taking into account a distance defined by the displacement up to the stop.

7. The method according to claim 5, wherein the calculation of the speed attribute takes into account a variation of a distance of the displacement by time unit.

8. The method according to claim 5, wherein the set of coordinates comprises most recent coordinates which are the last acquired coordinates along the locus of the displacement, and further comprises the step of updating said direction attribute and/or said speed attribute are based on the most recent set of coordinates.

9. The method according to claim 5, wherein said method further comprises the following steps:
detecting a second pressure point on the touch-sensitive device and determining a set of coordinates for said second pressure point,
detecting at least one displacement of said second pressure point while pressure is maintained on the touch-sensitive device and determining at least one further set of coordinates along a locus described by said displacement of said second pressure point,
calculating at least a direction attribute based on the plurality of sets of coordinates related to said second pressure point,
updating the current view by moving at least part of the current view according to a combination of at least the plurality of direction attributes,
continuing to update the current view by moving at least part of the current view according to the combination of at least the plurality of direction attributes until the plurality of pressure points are released from the touch-sensitive device.
